(19) United States
(12) Patent Application Publication
(10) Pub. No.: US 2024/0379982 A1
(43) Pub. Date: Nov. 14, 2024

(54) SOLID OXIDE FUEL CELLS WITH 3D INKJET-PRINTED MICROSTRUCTURES AND METHOD FOR FABRICATING THE SAME

(71) Applicants: Ryan MILCAREK, Gilbert, AZ (US); Qiong NIAN, Chandler, AZ (US); Yan DOU, Tempe, AZ (US); Jiashen TIAN, Ballston Spa, NY (US)

(72) Inventors: Ryan MILCAREK, Gilbert, AZ (US); Qiong NIAN, Chandler, AZ (US); Yan DOU, Tempe, AZ (US); Jiashen TIAN, Ballston Spa, NY (US)

(73) Assignee: Arizona Board of Regents on Behalf of Arizona State University, Scottsdale, AZ (US)

(21) Appl. No.: 18/661,485

(22) Filed: May 10, 2024

Related U.S. Application Data
(60) Provisional application No. 63/501,379, filed on May 10, 2023.

(51) Int. Cl. H01M 8/1213; H01M 4/88; H01M 4/90; H01M 8/12; H01M 8/1253

(52) U.S. Cl. CPC H01M 8/1213; H01M 4/8832; H01M 4/886; H01M 4/9033; H01M 8/1253; H01M 2008/1293

(57) ABSTRACT

A solid oxide fuel cell (SOFC) and method for fabricating the same is disclosed. The SOFC includes an anode layer, an electrolyte layer deposited on the anode layer, and a plurality of microstructures deposited on the electrolyte layer. Each microstructure includes a plurality of layers of microstructure ink including a microstructure material. The SOFC also includes a cathode layer deposited on the electrolyte layer and the plurality of microstructures. Each microstructure may be shaped like a frustum having a first and second base. The first base is substantially parallel to the second base. The method includes depositing the electrolyte layer on the anode layer, constructing the plurality of microstructures on the electrolyte layer by printing a plurality of layers of microstructure ink directly on to the electrolyte layer using an inkjet printing system, then depositing a cathode layer upon the electrolyte layer and the plurality of microstructures.

### RELATED APPLICATIONS

This application claims the benefit of U.S. provisional patent application 63/501,379, filed May 10, 2023, titled “Solid Oxide Fuel Cells with 3D Inkjet Printing Modified LSM-YSZ Interface,” the entirety of the disclosure of which is hereby incorporated by this reference.

### TECHNICAL FIELD

Aspects of this document relate generally to solid oxide fuel cells and methods for fabricating the same.

### BACKGROUND

Solid oxide fuel cells (SOFCs) have drawn attention as an alternative power generation technology due to demonstrated high efficiency and low emissions [1-5]. In SOFCs, the lanthanum strontium manganite (LSM)-yttria-stabilized zirconia (YSZ) cathode is widely utilized due to its high performance and stability [6]. The porous LSM-YSZ cathode can enhance the electrochemical oxygen reduction reaction that occurs in the cathode when there is sufficient electronic and ionic conductivity at high temperatures (800-1000° C.). With sufficient electrochemically active reaction sites, the oxygen ion transfer processes in the mixed ionic conductor (YSZ in the LSM) and at the interface of the cathode and electrolyte (LSM-YSZ) become critical for the activity of the cathode [7,8]. Because the electrochemical reactions mainly occur near the electrode/electrolyte interface, the structure of the LSM-YSZ cathode/YSZ electrolyte interface has a significant influence on the performance of the cell [9]. In this regard, improving the structure of the LSM-YSZ cathode/YSZ electrolyte interface is a method for SOFC performance enhancement.

Several additive manufacturing techniques have been studied to reduce the manufacturing costs and potentially enhance the interfaces of SOFCs. Pesce et al. utilized stereolithography printing to develop a corrugated YSZ layer for electrolyte supported SOFCs [10]. The corrugated structure had the same projected area compared to a planar reference, but a greater effective area, which resulted in higher total power generation while maintaining nearly identical power density per effective area. The results indicate the feasibility of the additive manufacturing technique, but do not show a direct increase in electrochemical performance. Modeling of pillar-shaped microstructures at electrode/electrolyte interfaces, which can be implemented with additive manufacturing, indicates that the ion conducting pathways are reduced [11]. Seo et al. investigated mesoscale structural improvements to the anode/electrolyte interface, and observed an increase in power density [12].

Inkjet printing is a versatile printing/additive manufacturing technology characterized by ease of operation and precise control. In addition, piezoelectric inkjet printing technology does not require heating of the ink, which expands the range of ink chemistry options. Through the design of the print pattern on the corresponding software, such as AGE 3000, an accurate pattern, shape, and structure can be easily and quickly printed with any appropriate functional material. These characteristics make inkjet printing scalable for commercial applications in low-cost and high-volume printed products. Recently, inkjet printing has been used to manufacture high-quality films in a time-saving and convenient way, especially in the field of functional film devices, such as optics [13,14], electronics [15,16], batteries [17,18] and supercapacitors [19,20].

Inkjet printing has the potential to overcome many manufacturing difficulties in thin-film based SOFC technology. For example, in contrast to contact methods such as screen printing [21,22] or cast tape [23,24], which have less control of overall shape and size, inkjet printing technology has the ability to control ink droplets to make them more regular in shape and more accurately positioned, resulting in higher printing resolution. Inkjet printing surpasses current physical and chemical vapor deposition (CVD/PVD) in manufacturing cost-effectiveness and scalability, though these deposition processes can improve the electrochemical properties of materials at the nanoscale. Another promising aspect of inkjet printing is the capability to print delicate micro 3D structures with unique patterns designed in the software, and thereby lead to advanced digital manufacturing. Through this approach, a microstructure of YSZ printed at the cathode interface can be engineered, e.g., into 3D pillar-shapes.

Some previous studies explored 3D inkjet printing to fabricate the 3D microstructure between the electrolyte and electrode for the solid oxide electrochemical device [26]. For instance, Farandos et al. applied aqueous inks with varying YSZ particle size and polymer binder concentration to fabricate the planar electrolyte of solid oxide cells. In their work, 3D YSZ micro-pillar arrays and square lattices between the YSZ electrolyte and LSM-YSZ cathode, with a minimum resolution of 35 μm horizontally, were fabricated. El-Toni et al. utilized 3D inkjet printing to create a CGO layer on honeycomb shape LSM supported SOFCs [28]. In order to increase the TPB and reaction sites, Jang et al. constructed a Ni-YSZ anode support layer with the circular pillars printed at the anode/electrolyte interface through 3D inkjet printing. The electrochemical testing results illustrated the 3D microstructures can enhance the SOFCs' performance due to the increasing TPB area. However, more work in SOFC additive manufacturing is needed to enhance the microstructure and triple phase boundary (TPB) region to understand how adjustments to the interfaces can enhance the electrochemical performance.

Previous approaches to solid oxide fuel cells have typically involved the use of conventional planar designs with flat layers of materials. These conventional designs have limitations in terms of efficiency and performance due to the lack of effective microstructure control and optimization. The conventional flat layers do not provide sufficient surface area for electrochemical reactions to occur efficiently, leading to lower power output and reduced overall cell performance.

In some instances, attempts have been made to enhance the performance of solid oxide fuel cells by incorporating microstructures on the surface of the electrolyte layer. However, these microstructures have been limited in their design and fabrication methods, often relying on complex and costly manufacturing processes that do not allow for precise control over the shape and size of the microstructures. Additionally, the materials used for these microstructures have not been optimized for maximum efficiency and durability, resulting in limited improvements in cell performance.

Furthermore, the application of microstructures on solid oxide fuel cells has been primarily limited to simple geometries, such as pillars or dots, which do not provide optimal surface area for electrochemical reactions. The lack of tailored microstructure designs that can enhance the performance of the fuel cell by promoting efficient gas diffusion and reaction kinetics has been a significant drawback in the development of high-performance solid oxide fuel cells. However, none of these approaches have provided a comprehensive solution that combines the features contemplated herein.

### SUMMARY

According to one aspect, a solid oxide fuel cell includes an anode layer including yttria-stabilized zirconia (YSZ) and NiO, an electrolyte layer including YSZ deposited upon the anode layer, and a plurality of microstructures having a microstructure material and deposited upon the electrolyte layer. Each microstructure is composed of a plurality of layers of microstructure ink that have been applied by an inkjet printing system and sintered. The microstructure ink includes YSZ. The solid oxide fuel cell also includes a cathode layer deposited upon the electrolyte layer and the plurality of microstructures. The cathode layer includes lanthanum strontium manganite (LSM) and YSZ. Each microstructure of the plurality of microstructures is shaped like a conical frustum having a first base and a second base. The first base is substantially parallel to the second base. The microstructure is coupled to the electrolyte layer through the second base. A ratio between an area of the first base and an area of the second base is less than 0.5.

Particular embodiments may comprise one or more of the following features. Each layer of the plurality of layers of microstructure ink may be at most 0.3 μm thick.

According to another aspect of the disclosure, a solid oxide fuel cell includes an anode layer, an electrolyte layer deposited upon the anode layer, and a plurality of microstructures including a microstructure material and deposited upon the electrolyte layer. Each microstructure is composed of a plurality of layers of microstructure ink that have been applied by an inkjet printing system and sintered. The microstructure ink includes the microstructure material. The solid oxide fuel cell also includes a cathode layer deposited upon the electrolyte layer and the plurality of microstructures.

Particular embodiments may comprise one or more of the following features. Each microstructure of the plurality of microstructures may be shaped like a frustum having a first base and a second base. The first base may be substantially parallel to the second base. The microstructure may be coupled to the electrolyte layer through the second base. The frustum may be a conical frustum. The frustum may be an elliptical frustum. A ratio between an area of the first base and an area of the second base may be less than 0.5. Each layer of the plurality of layers of microstructure ink may be at most 0.3 μm thick. Each microstructure of the plurality of microstructures may be composed of at least 160 layers of microstructure ink. The anode layer may include yttria-stabilized zirconia (YSZ) and NiO. The cathode layer may include lanthanum strontium manganite (LSM) and YSZ. The electrolyte layer may include YSZ. The microstructure material may be YSZ.

According to yet another aspect of the disclosure, a method for fabricating a solid oxide fuel cell includes depositing an electrolyte layer upon an anode layer, and constructing a plurality of microstructures upon the electrolyte layer by printing a plurality of layers of microstructure ink directly on to the electrolyte layer using an inkjet printing system. The microstructure ink includes a microstructure material. The method also includes depositing a cathode layer upon the electrolyte layer and the plurality of microstructures.

Particular embodiments may comprise one or more of the following features. The method may also include creating the microstructure ink by ball milling the microstructure material and a solvent. Each microstructure of the plurality of microstructures may be shaped like a frustum having a first base and a second base. The first base may be substantially parallel to the second base, and the microstructure may be coupled to the electrolyte layer through the second base. The frustum may be a conical frustum. The frustum may be an elliptical frustum. A ratio between an area of the first base and an area of the second base may be less than 0.5. Each layer of the plurality of layers of microstructure ink may be at most 0.3 μm thick. Printing the plurality of layers of microstructure ink directly on to the electrolyte layer using the inkjet printing system may include printing at least 160 layers of microstructure ink. The anode layer may include yttria-stabilized zirconia (YSZ) and NiO. The cathode layer may include lanthanum strontium manganite (LSM) and YSZ. The electrolyte layer may include YSZ. The microstructure material may be YSZ. The electrolyte layer and the cathode layer may both be deposited using a wet powder spray process.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A is a perspective view of a solid oxide fuel cell;

FIG. 1B is a cross sectional view of the solid oxide fuel cell of FIG. 1A taken along line AA;

FIG. 2 is a process view of a method for fabricating a solid oxide fuel cell;

FIGS. 3A, 3B, and 3C are perspective, top, and side views of a frustum shape;

FIGS. 4A and 4B are top view SEM images of an electrolyte layer with microstructures made of 80 and 160 inkjet-printed layers, respectively;

FIGS. 5A and 5B are cross-sectional SEM images of an electrolyte layer with microstructures made of 80 and 160 inkjet-printed layers, respectively;

FIG. 6 shows polarization curves of SOFCs with planar YSZ electrolyte, 40 layers and 80 layers inkjet-printed microstructures;

FIG. 7 shows EIS results of SOFCs with planar YSZ electrolyte, 40 layers and 80 layers inkjet-printed microstructures; and

FIG. 8 shows a DRT plot from EIS results of SOFCs with planar YSZ electrolyte, 40 layers and 80 layers inkjet-printed microstructures.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Solid oxide fuel cells (SOFCs) have drawn attention as an alternative power generation technology due to demonstrated high efficiency and low emissions [1-5]. In SOFCs, the lanthanum strontium manganite (LSM)-yttria-stabilized zirconia (YSZ) cathode is widely utilized due to its high performance and stability [6]. The porous LSM-YSZ cathode can enhance the electrochemical oxygen reduction reaction that occurs in the cathode when there is sufficient electronic and ionic conductivity at high temperatures (800-1000° C.). With sufficient electrochemically active reaction sites, the oxygen ion transfer processes in the mixed ionic conductor (YSZ in the LSM) and at the interface of the cathode and electrolyte (LSM-YSZ) become critical for the activity of the cathode [7,8]. Because the electrochemical reactions mainly occur near the electrode/electrolyte interface, the structure of the LSM-YSZ cathode/YSZ electrolyte interface has a significant influence on the performance of the cell [9]. In this regard, improving the structure of the LSM-YSZ cathode/YSZ electrolyte interface is a method for SOFC performance enhancement.

Several additive manufacturing techniques have been studied to reduce the manufacturing costs and potentially enhance the interfaces of SOFCs. Pesce et al. utilized stereolithography printing to develop a corrugated YSZ layer for electrolyte supported SOFCs [10]. The corrugated structure had the same projected area compared to a planar reference, but a greater effective area, which resulted in higher total power generation while maintaining nearly identical power density per effective area. The results indicate the feasibility of the additive manufacturing technique, but do not show a direct increase in electrochemical performance. Modeling of pillar-shaped microstructures at electrode/electrolyte interfaces, which can be implemented with additive manufacturing, indicates that the ion conducting pathways are reduced [11]. Seo et al. investigated mesoscale structural improvements to the anode/electrolyte interface, and observed an increase in power density [12].

Inkjet printing is a versatile printing/additive manufacturing technology characterized by ease of operation and precise control. In addition, piezoelectric inkjet printing technology does not require heating of the ink, which expands the range of ink chemistry options. Through the design of the print pattern on the corresponding software, such as AGE 3000, an accurate pattern, shape, and structure can be easily and quickly printed with any appropriate functional material. These characteristics make inkjet printing scalable for commercial applications in low-cost and high-volume printed products. Recently, inkjet printing has been used to manufacture high-quality films in a time-saving and convenient way, especially in the field of functional film devices, such as optics [13,14], electronics [15,16], batteries [17,18] and supercapacitors [19,20].

Inkjet printing has the potential to overcome many manufacturing difficulties in thin-film based SOFC technology. For example, in contrast to contact methods such as screen printing [21,22] or cast tape [23,24], which have less control of overall shape and size, inkjet printing technology has the ability to control ink droplets to make them more regular in shape and more accurately positioned, resulting in higher printing resolution. Inkjet printing surpasses current physical and chemical vapor deposition (CVD/PVD) in manufacturing cost-effectiveness and scalability, though these deposition processes can improve the electrochemical properties of materials at the nanoscale. Another promising aspect of inkjet printing is the capability to print delicate micro 3D structures with unique patterns designed in the software, and thereby lead to advanced digital manufacturing. Through this approach, a microstructure of YSZ printed at the cathode interface can be engineered, e.g., into 3D pillar-shapes.

Some previous studies explored 3D inkjet printing to fabricate the 3D microstructure between the electrolyte and electrode for the solid oxide electrochemical device [26]. For instance, Farandos et al. applied aqueous inks with varying YSZ particle size and polymer binder concentration to fabricate the planar electrolyte of solid oxide cells. In their work, 3D YSZ micro-pillar arrays and square lattices between the YSZ electrolyte and LSM-YSZ cathode, with a minimum resolution of 35 μm horizontally, were fabricated. El-Toni et al. utilized 3D inkjet printing to create a CGO layer on honeycomb shape LSM supported SOFCs [28]. In order to increase the TPB and reaction sites, Jang et al. constructed a Ni-YSZ anode support layer with the circular pillars printed at the anode/electrolyte interface through 3D inkjet printing. The electrochemical testing results illustrated the 3D microstructures can enhance the SOFCs' performance due to the increasing TPB area. However, more work in SOFC additive manufacturing is needed to enhance the microstructure and triple phase boundary (TPB) region to understand how adjustments to the interfaces can enhance the electrochemical performance.

Contemplated herein is a solid oxide fuel cell having three dimensional inkjet-printed microstructures, and a method for fabricating the same. Previous studies have shown that the geometry of the electrode/electrolyte interface of a solid oxide fuel cell can have a significant impact on its performance. However, the exact mechanism for this influence has not been well understood, and while some improvements have been achieved through increasing the active area in the triple phase boundary, those efforts have focused on the actual size of the area instead of other aspects of the geometry.

The triple phase boundary is the active area between the electrolyte and the cathode, and is where the electrochemical reaction happens. It is widely believed that this reaction is one of the slowest reactions to occur in a fuel cell, and is a key limiting step to the overall performance. The SOFC contemplated herein grew out of an effort to modify the triple phase boundary to accelerate the reaction, resulting in a higher performing fuel cell.

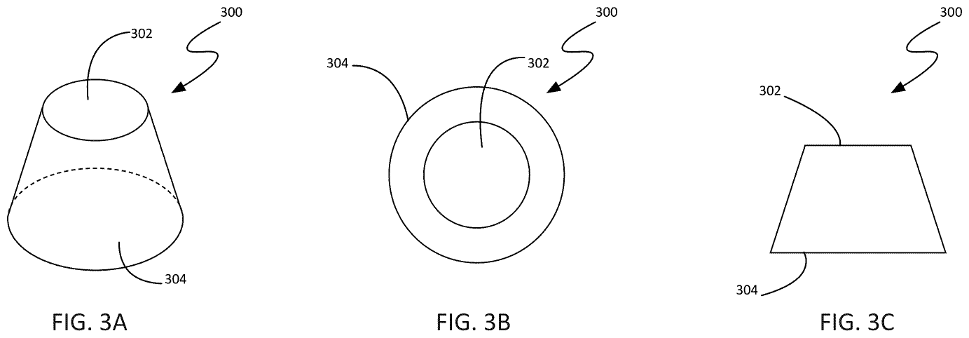

The SOFC contemplated herein comprises a plurality of microstructures on the electrolyte layer, between the electrolyte layer and the cathode layer. According to various embodiments, each of these microstructures may be shaped like a frustum, which is what is left over after a shape has been sliced by two parallel planes (a more precise definition is discussed below, in the context of FIGS. 3A-3C). Some particular embodiments were fabricated and characterized, in an effort to show improved performance.

That improved performance was indeed found, but to a greater degree than expected. As will be discussed below, in a particular embodiment of the contemplated SOFC, adding the microstructures resulted in a modest increase (i.e., 2.4% to 4%) in the active area compared to an SOFC without any microstructures. However, that modest increase led to larger than anticipated increases in power density which did not scale linearly with the active area. Specifically, the maximum power densities of solid oxide fuel cells with 80 and 160 3D inkjet-printed interfacial layers, in the form of frustum-shaped microstructures, increased 16 mW cm⁻² (15.1%) and 66 mW cm⁻² (62.3%), respectively, compared with the SOFC having a planar electrolyte. The non-linear improvement in power density with the size of microstructures has confirmed with repeated tests.

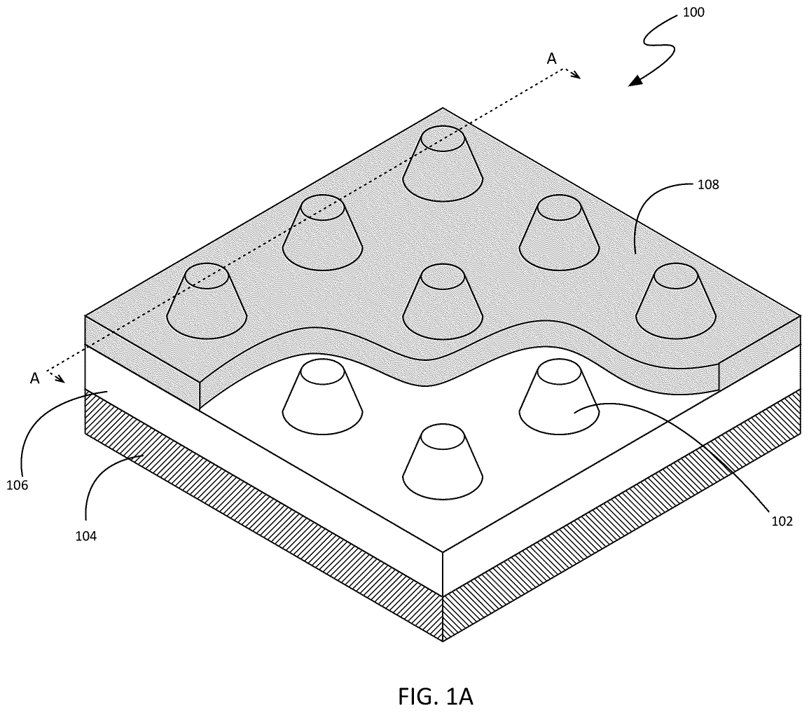

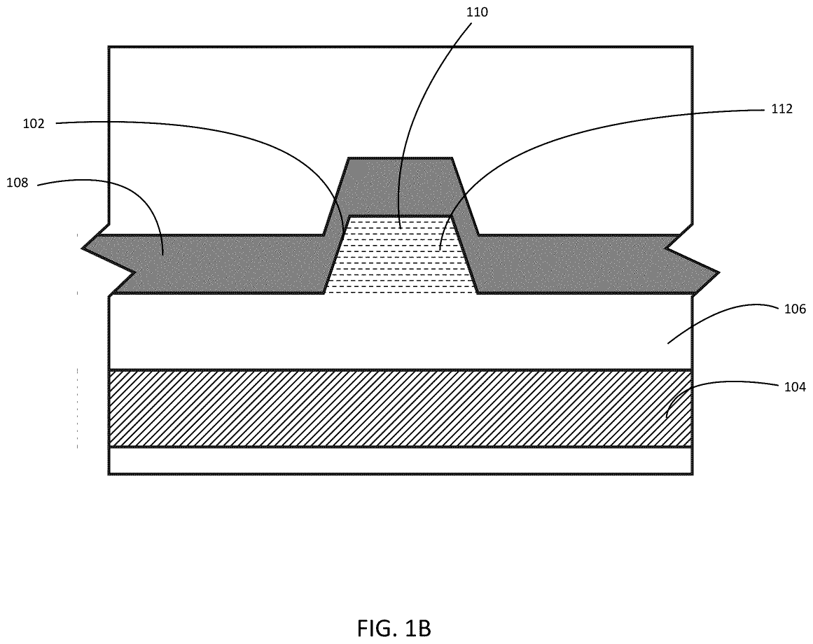

FIGS. 1A and 1B are schematic views of a non-limiting example of a solid oxide fuel cell 100. Specifically, FIG. 1A shows a perspective cut-away view of the solid oxide fuel cell 100. FIG. 1B shows a close-up cross sectional view of the solid oxide fuel cell 100 taken along line AA. As shown, the solid oxide fuel cell 100 comprises an anode layer 104, a cathode layer 108, and an electrolyte layer 106 sandwiched between the anode layer 104 and the cathode layer 108. It should be noted that the schematic views shown in FIGS. 1A and 1B are not drawn to scale, including the thickness of these layers and the arrangement of the microstructures 102.

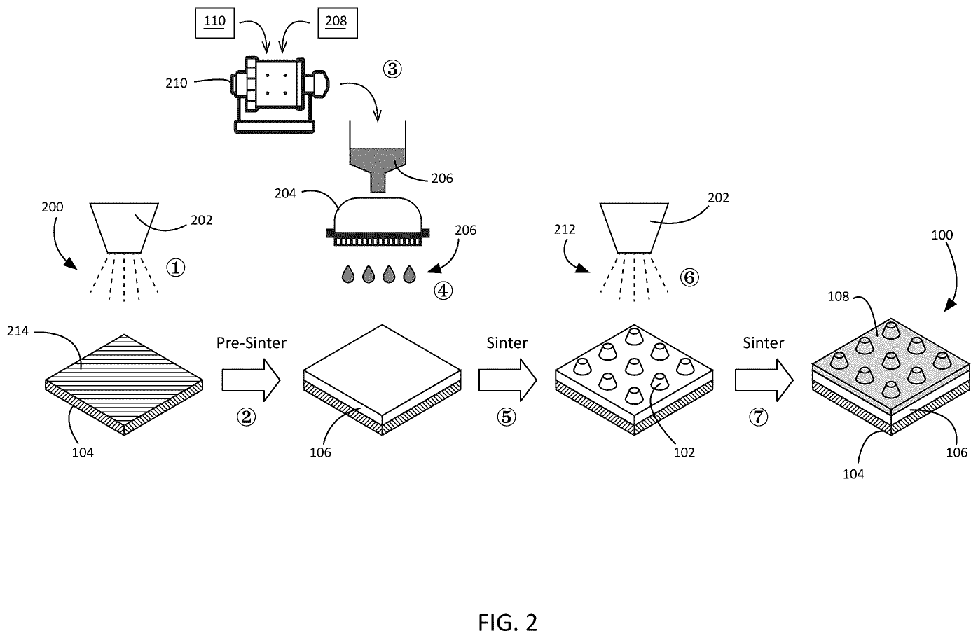

Between the electrolyte layer 106 and the cathode layer 108, the solid oxide fuel cell 100 contemplated herein comprises a plurality of microstructures 102. The microstructures 102 are made up of a microstructure material 110 that has been deposited upon the electrolyte layer 106. According to various embodiments, each microstructure 102 is made up of a plurality of layers of microstructure ink 206 that have been applied using an inkjet printing system (i.e., the inkjet printing system 204 of FIG. 2).

In some embodiments, the solid oxide fuel cell 100 has an anode-supported cell design, meaning the anode layer 104 also serves as a structural backbone for the cell. In other embodiments, the solid oxide fuel cell 100 may employ a different design, depending on the intended use environment and the materials being used. In some embodiments, the anode layer 104 comprises yttria-stabilized zirconia (YSZ) and NiO, the cathode layer 108 comprises lanthanum strontium manganite (LSM) and YSZ, and the electrolyte layer 106 and/or the microstructure material 110 comprises YSZ.

In some embodiments, the electrolyte layer 106 and the microstructure material 110 may be composed of the same material. For example, the electrolyte layer 106 and the microstructure material 110 may both comprise YSZ. In other embodiments, the electrolyte layer 106 and the microstructure material 110 may be composed of different materials, so long as they are compatible (e.g., similar enough to avoid interfacial reactions, etc.). For example, the electrolyte layer 106 may comprise YSZ and the microstructure material 110 may comprise a material that is compatible with YSZ.

In still other embodiments, the contemplated fuel cell design having microstructures may be adapted for use with other materials known in the art of solid oxide fuel cells. Examples include, but are not limited to, Gd_{0.1}Ce_{0.9}O_{1.95}, Gd_{0.20}Ce_{0.80}O_{1.95}, Sm_{0.20}Ce_{0.80}O_{1.95}, (Sc₂O₃)_{0.10}(ZrO₂)_{0.90}, La_{0.80}Sr_{0.20}Ga_{0.80}Mg_{0.20}O_{3-X}.

As shown in FIG. 1B, each microstructure 102 is composed of microstructure material 110 deposited as a plurality of layers 112. These layers 112 created by printing a sequence of overlapping point arrays of microstructure ink 206 using an inkjet printing system. This method of fabrication will be discussed in greater detail in the context of FIG. 2, below.

In some embodiments, each microstructure 102 may be composed of 40 layers 112. In other embodiments, each microstructure 102 may be composed of 80 layers 112. Still other embodiments may be composed of at least 160 layers 112. Other embodiments may comprise even more layers 112.

The thickness of each layer 112 of microstructure material 110 may vary from embodiment to embodiment, depending upon various factors including, but not limited to, properties of the inkjet printing system (e.g., the drop size, nozzle diameter, etc.), properties of the microstructure ink 206 (e.g., particle size of the microstructure material 110, solvent used, ratio of solvent to microstructure material 110, viscosity, etc.), and the like. In some embodiments, each layer 112 of the plurality of layers 112 of microstructure material 110 that make up a microstructure 102 may be at most 0.125 μm thick. In other embodiments, each layer 112 may be at most 0.15 μm thick. In still other embodiments, each layer 112 may be at most 0.30 μm thick. In other embodiments, each layer 112 may be at most 0.50 μm thick. In other embodiments, each layer 112 may be at least 0.50 μm thick.

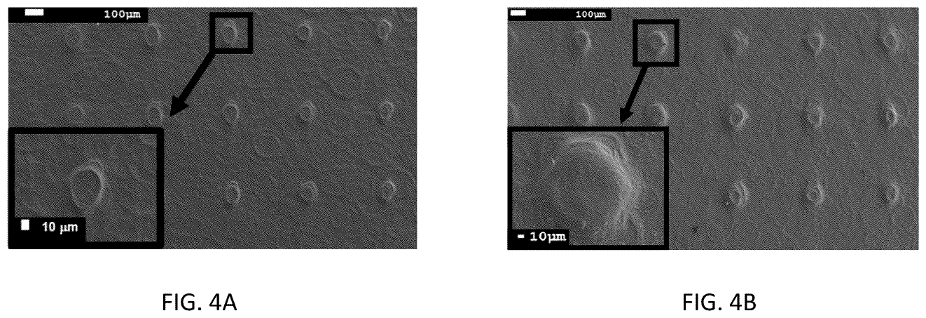

FIG. 2 is a process view of a non-limiting example of a method for fabricating the contemplated solid oxide fuel cell 100 using a three dimensional inkjet printing process. While the following discussion will proceed in the context of various embodiments and discuss the general principles of the contemplated method, it will also be accompanied by the discussion of the parameters for a specific, non-limiting example of the use of this method to create specific embodiments of the contemplated solid oxide fuel cell 100. The solid oxide fuel cell 100 resulting from these specific, non-limiting examples of fabrication, hereinafter referred to as “the particular embodiments” was later characterized. The characterization of the particular embodiments will be discussed in the context of FIGS. 4A-8, below.

It should be noted that while the following discussion of the contemplated method is being done in the context of a solid oxide fuel cell 100 having an anode-supported design, other embodiments of this method are directed to different designs, including cell designs that do not rely upon the anode layer 104 for structural support. The following examples should not be interpreted as limiting the contemplated method to solid oxide fuel cells having an anode-supported architecture.

The contemplated method begins with an anode layer 104. In some embodiments, the anode layer 104 may be a layer of anode material 214 that is commercially available. In other embodiments, the anode layer 104 may itself be fabricated as part of the contemplated method, using techniques known in the art. As a specific example, in the particular embodiment, a supported anode layer 104 composed of NiO and YSZ was created by dry pressing NiO+YSZ (i.e., 60:40 w/w, Nexceris-Fuelcellmaterials), and then pre-sintering the anode material 214 at 1100° C. for 4 hours.

Whether the anode layer 104 is an off-the-shelf segment of anode material 214, or whether the anode layer 104 has been fabricated, the next step is depositing an electrolyte layer 106 upon the anode layer 104. See ‘Circle 1’. The electrolyte layer 106 comprises an electrolyte material 200, which may be deposed or otherwise deposited on the anode layer 104 using any technique known in the art including, but not limited to, a wet powder spray 202 process, as shown.

As a specific example, in the particular embodiments, the electrolyte material 200 is YSZ, which was sprayed onto the surface of the anode layer 104 as an yttria-stabilized zirconia (i.e., (ZrO₂)_{0.92}(Y₂O₃)_{0.08}, Nexceris-Fuelcellmaterials) electrolyte slurry using a wet powder spray 202 process.

In some embodiments, the electrolyte layer 106 and the anode layer 104 are then pre-sintered after the electrolyte layer 106 has been deposited on the anode layer 104. See ‘Circle 2’. As a specific example, in the particular embodiments, the electrolyte layer 106 and anode layer 104 were pre-sintered together at 1100° C. for 4 hours.

In some embodiments, before the microstructures 102 can be “printed” on the electrolyte layer 106, a microstructure ink 206 is synthesized. See ‘Circle 3’. The microstructure ink 206 is a fluid comprising a microstructure material 110 (e.g., a suspension of microstructure material 110, etc.) that can be ejected from an inkjet printing system 204 in a manner consistent enough to produce the desired 3D microstructures through layered deposition. In some embodiments, the microstructure ink 206 is created by ball milling a microstructure material 110 and a solvent 208 in a ball mill 210, as shown. In other embodiments, the microstructure material 110 may be processed (e.g., ball milled, etc.) before mixing with a solvent 208. As an option, in some embodiments the microstructure material 110 may be filtered to limit the material to a maximum particle size before mixing with solvent 208. In some embodiments, the milling endpoint may be treated as a function of measured viscosity rather than a determination of particle size.

As a specific example, in the particular embodiments, the microstructure ink 206 was formulated by adding 10 wt % of YSZ powder (i.e., TZ8Y, Tosoh Corporation, ZrO₂ stabilized with 8 mol % Y₂O₃) in a 5:1 v/v mixture of EG (i.e., Sigma Aldrich, ethylene glycol, 99.8%) and glycerol (i.e., Sigma Aldrich), and then ball milled for 24 hours, or until a desired viscosity was achieved.

Next, a plurality of microstructures 102 are constructed upon the electrolyte layer 106 by printing a plurality of layers 112 of microstructure ink 206 directly on to the electrolyte layer 106 using an inkjet printing system 204. See ‘Circle 4’.

In the context of the present description and the claims that follow, an inkjet printing system 204 is a versatile digital printing technology in which minute droplets of a fluid material (e.g., microstructure ink 206, etc.) are precisely ejected from a print head onto a substrate (e.g., the anode layer 104, etc.) to form an image or structure (e.g., array of microstructures 102, etc.). According to various embodiments, the controlled formation and ejection of the droplets may be accomplished using various techniques including, but not limited to, piezoelectric, thermal, and the like, including techniques not yet developed.

In some embodiments, the inkjet printing system 204 may be a reconfigured consumer device intended for depositing images on paper. In other embodiments, the inkjet printing system 204 may be a device configured specifically for the controlled deposition of various materials including suspensions of very small particles.

According to various embodiments, the three dimensional microstructures 102 are essentially stacks of overlapping layers 112 of point arrays composed of droplets of microstructure ink 206. The more layers 112 deposited, the taller the resulting microstructures 102 will be. As previously discussed, the actual thickness of each layer 112 will depend on a number of variables.

As a specific example, in the particular embodiments, a Dimatix DMP (Dimatix Material Printer) 2850 inkjet printing system (i.e., Dimatix DMP-2850, FUJIFILM, USA) configured with a 21 μm nozzle diameter, and calibrated with a 10 pL drop size was utilized to print the plurality of microstructures 102 using the specific YSZ microstructure ink 206 discussed above.

In one particular embodiment, the plurality of microstructures 102 were made by printing 80 layers directly on the YSZ electrolyte layer 106, while in another particular embodiment 160 layers were printed. In both particular embodiments, the layers 112 were printed using single droplet deposition at 60° C., with a 300 μm inter-microstructure spacing.

The microstructures 102 are then sintered along with the electrolyte layer 106 and the anode layer 104. See ‘Circle 5’. As a specific example, in the particular embodiments, the YSZ electrolyte layer 106 with YSZ microstructures 102 and NiO-YSZ anode layer 104 were co-sintered at 1400° C. for 4 hours.

Next, a cathode layer 108 is deposited on top of the electrolyte layer 106 and the plurality of microstructures 102. See ‘Circle 6’. The cathode layer 108 comprises a cathode material 212, which may be deposed or otherwise deposited using any technique known in the art including, but not limited to, a wet powder spray 202 process, as shown.

As a specific example, in the particular embodiments, the cathode material 212 was a 50:50 w/w mixture of YSZ and strontium-doped lanthanum manganite (LSM, (La_{0.80}Sr_{0.20})_{0.95}MnO_{3-X}, Nexceris-Fuelcellmaterials) that was deposited on the electrolyte layer 106 and the microstructures 102 using a wet powder spray 202 process.

Finally, the solid oxide fuel cell 100 is sintered. See ‘Circle 7’. As a specific example, in the particular embodiments, the cells 100 were sintered at 1100° C. for 2 hours in air. After sintering, the thickness of the electrolyte, cathode and anode layers in these particular embodiments were ˜12 μm, ˜17 μm, and 380 μm, respectively.

The microstructures 102 may have a variety of shapes. Variations in properties including, but not limited to, the profile, cross section, and the nature of the electrode-facing surface/face of the microstructure 102 exist across many embodiments. For example, in some embodiments, the microstructure 102 may be shaped like a frustum 300.

FIGS. 3A, 3B, and 3C are perspective, top, and side views of a frustum 300 shape, respectively. In the context of the present description and the claims that follow, a frustum 300 is a three dimensional shape that results when a three dimensional shape is sliced by two planes (i.e., first base 302 and second base 304) that are parallel or substantially parallel to each other; the frustum 300 is the shape between these two cutting planes.

Within the context of this definition, In the context of the present description and the claims that follow, the first base 302 is a plane that is substantially parallel to the second base 304 (another plane). To facilitate the following discussion, the second base 304 is the plane of interface between the microstructure 102 and the electrolyte layer 106. Due to the method of creating the microstructure 102 (i.e., printing layers 112 of microstructure ink 206 onto the electrolyte layer 106), the interface between the microstructure 102 and the electrolyte layer 106 will be considered planar. Put differently, each microstructure 102 is coupled to the electrolyte layer 106 through its second base 304.

It should be noted that this is a slight departure from the classical definition of a frustum which requires that a cutting plane be parallel to an already extant planar face of the originating shape, which would preclude shapes lacking planar faces such as a torus or a sphere.

Another departure from the classical definition of frustum is the expansion of the relative orientation of the two cutting planes to include “substantially parallel”. In the context of the present description and the claims that follow, “substantially parallel” means that the two planes are parallel, or sufficiently close to being parallel that their angle of intersection is less than 5 degrees. Since in reality these two planes are typically not perfectly planar (e.g., coffee ring effect, etc.), the planes being considered are the planes “best fit” to the actual surfaces.

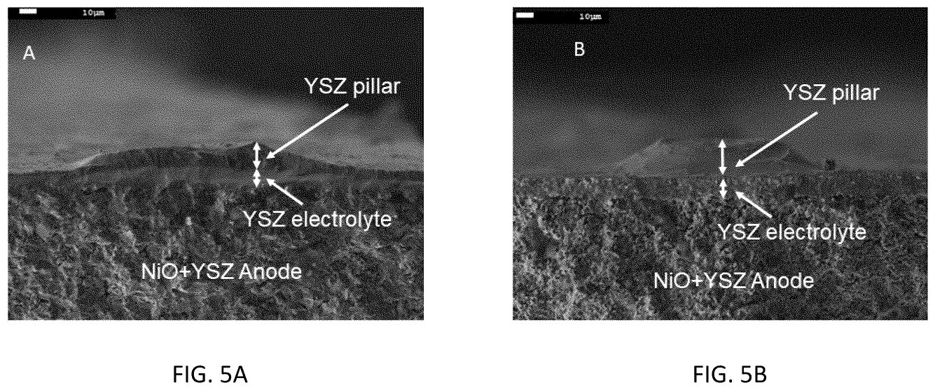

There are different types of frustum 300 shapes. The non-limiting example shown in FIGS. 3A-3C is a conical frustum, or a truncated cone. A similar example is an elliptical frustum, which has an elliptical cross section. Both shapes are exhibited in the SEM images of the particular embodiments discussed with respect to FIGS. 4A-5B. Other frustum types include pyramidal (e.g., triangular, square, rectangular, hexagonal, etc.), cylindrical (e.g., a smaller cylinder, etc.), and the like.

Not only does the frustum 300 shape, as defined herein, provide a broad framework in which various microstructure 102 embodiments may be discussed, it is also an apt description of a microstructure shape that exhibits unexpected performance improvements. The frustum shape is exhibited by the particular microstructures 102 seen in the particular embodiments whose fabrication has been described above and whose characterization will be discussed, below.

The triple phase boundary is the active area between the electrolyte and the cathode, and is where the electrochemical reaction happens. It is widely believed that this reaction is one of the slowest reactions to occur in a fuel cell, and is a key limiting step to the overall performance. The SOFC contemplated herein grew out of an effort to modify that interface (i.e., the triple phase boundary) to accelerate the reaction, resulting in a higher performing fuel cell.

That improved performance was indeed found, but to a greater degree than expected. As will be discussed below, in particular embodiments of the contemplated solid oxide fuel cell 100, adding the microstructures 102 resulted in a modest increase (i.e., 2.4% to 4%) in the active area compared to an SOFC without any microstructures 102. However, that modest increase led to larger than anticipated increases in power density which did not scale linearly with the active area. Specifically, the maximum power densities of solid oxide fuel cells 100 with 80 and 160 3D inkjet-printed interfacial layers 112 increased 16 mW cm⁻² (15.1%) and 66 mW cm⁻² (62.3%), respectively, compared with a near identical SOFC having a planar electrolyte layer 106 and no microstructures 102.

These unexpected results were observed in the particular embodiments whose frustum 300 is tapered, meaning the second base 304 is larger than the first base 302. In some embodiments, unexpected performance may be observed when the ratio between the area of the first base 302 and the area of the second base 304 is less than 0.5. In other embodiments, the ratio is less than 0.4.

The particular embodiments discussed above were fabricated and characterized. Additionally, planar SOFCs without YSZ microstructures 102 were also fabricated by skipping the 3D inkjet printing step. They were utilized for the performance comparison with the SOFCs having a 3D inkjet-printed interfacial layer.

The following examples are to further illustrate the nature of the invention and are intended to be exemplary and non-limiting. It is believed that one of ordinary skill in the art can, using the preceding description and the following illustrative examples, make and utilize the present invention and practice the claimed methods. It should be understood that the following examples do not limit the invention and that the scope of the invention is to be determined by the appended claims.

For the electrochemical characterization tests, the SOFCs were sealed on the top of a quartz tube with silver paste. As the current collector, silver ink was painted on the cathode with 0.495 cm² active area. For electrochemical measurements, a pair of silver/steel wires were attached to the anode and cathode surface as probes. H₂ and N₂ flow rates were controlled by Brooks Delta II smart mass flow controllers (MFCs) for the anode fuel supply with LabView interface. In order to have a good comparison with previous work [30], the H₂ flow rate was maintained constant at 10 standard cubic centimeters per minute (sccm). The flow rate of N₂ gas was fixed at 10 sccm with the total flow rate of fuel gases (H₂, N₂) at 20 sccm. The air was supplied through natural convection to the cathode side of the SOFCs in the vertical furnace.

For all experiments performed, the quartz tube reactor was placed in the center of the vertical furnace. The furnace was heated at a rate of 5° C. per minute to an SOFC operating temperature at 800° C. To confirm the operating temperature, a K-type thermocouple was also placed near the SOFC. Before starting electrochemical characterization tests, the YSZ-NiO SOFC anode was supplied with H₂ and N₂ at flow rates of 10 sccm individually for 2 hours to reduce the NiO to Ni. Subsequently, the performance evaluation and electrochemical characterization tests including polarization curve and EIS were conducted.

Precision uncertainty was calculated for the power density and active area of the SOFCs with 80 and 160 inkjet-printed layers. Two cells each were prepared with the same conditions and 80 and 160 inkjet-printed layers in order to compare the SOFC performance at similar voltages and determine the overall uncertainty for power density using a 95% confidence interval. Multiple images were obtained of the microstructure shapes from different locations in the cell to determine average size, height, and a 95% confidence interval was used to estimate their overall uncertainty for the additional active area. Bias error for electrochemical characterization is attributed to the resolution limits of the Solartron Analytical Energylab XM analyzer. The max resolution limit for the voltage and current measurement is ±0.1% and ±0.25% respectively.

After the 3D inkjet printing and sintering, the morphology of the surface and cross-section of the cells before covering the cathode was investigated by a field emission scanning electron microscope (FESEM, JEOL JXA-8530F electron microprobe). The electron beam was selected as 15 kV at 5×10−8 A for the SEM analysis.

FIGS. 4A and 4B are top view SEM images of the electrolyte layer with microstructures made of 80 and 160 inkjet-printed layers, respectively. As discussed above, these microstructures are composed of printed layers of YSZ slurry, forming microstructures after sintering at 1400° C. for 4 hours.

As shown, the diameters of the microstructures 102 of these particular embodiments are around 60 μm to 90 μm. With 160 layers of YSZ printed, the shape of the microstructures 102 are nearly circular (i.e., a conical frustum), while having less layers printed resulted in non-uniformity in the shape (e.g., elliptical frustum, etc.). Crater-shaped structures can also be observed on the top of the microstructures 102, especially when only 80 layers of YSZ were printed. From a previous study [29], the coffee ring effect is the main reason crater structures are generated during the drying process.

FIGS. 5A and 5B are cross-sectional SEM images of an electrolyte layer with frustum-shaped microstructures made of 80 and 160 inkjet-printed layers, respectively.

As shown, in this particular embodiment 80 inkjet-printed layers can generate a microstructure with a height around 12 μm with the ink recipe discussed for the particular embodiments above. In comparison, having 160 inkjet-printed layers resulted in a microstructure height of ˜20 microns after sintering. Compared to the planar YSZ electrolyte layers generated by wet powder spray, the 3D inkjet-printed microstructures 102 also show a similar dense structure based upon the cross-section image. Overall, the morphology analysis results demonstrate that the YSZ microstructures were well-constructed by multi-layer points array 3D inkjet printing.

Using the SEM images shown in FIGS. 4AB and 5AB, as well as others obtained in the analysis, the active area was determined based on the number of layers deposited as shown in Table 1. The active area increases by 0.012 and 0.020 cm² for the cells with 80 and 160 inkjet-printed layers, respectively, compared to the original planar YSZ layer. The active area was determined by averaging the height and width of YSZ microstructures 102 for each SEM image obtained. The increase in active area varied linearly with the number of layers printed with a high coefficient of determination of 0.99 when a line was fitted to the values.

TABLE 1

| Number of layers printed | Active area (cm²) | % Increase |
|---|---|---|
| Planar | 0.495 | NA |
| 80 | 0.507 ± 0.0047 | 2.4 |
| 160 | 0.515 ± 0.0073 | 4.0 |

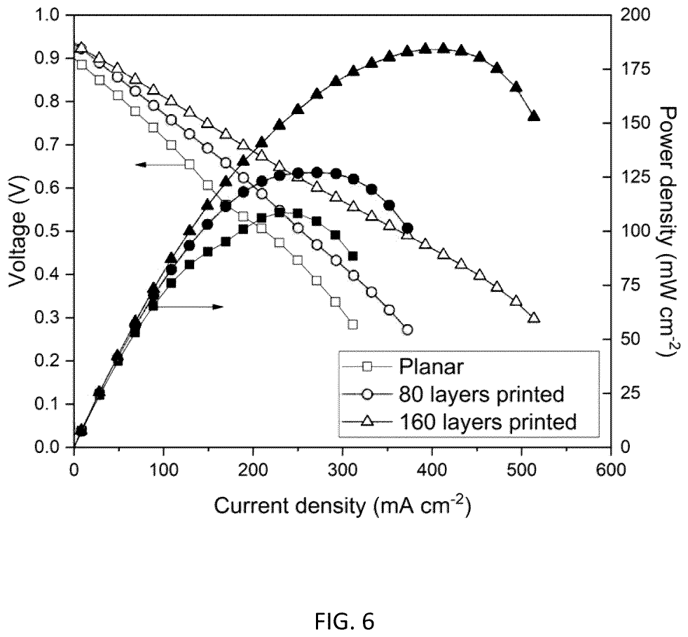

FIG. 6 shows polarization curves of the SOFCs with planar YSZ electrolyte, 40 layer, and 80 layer inkjet-printed microstructures. In order to have a quantitative investigation of the SOFCs performance with microstructures at the electrolyte/cathode interface, the polarization curves of the SOFCs operating at 800° C. were obtained and are shown in FIG. 6. The OCV of the SOFC is about 0.91 V, which is close to the theoretical OCV (i.e., 0.92 V) calculated from the Nernst equation based on diluted H₂ and O₂ as the fuel and oxidizer and our previous results with a similar fuel composition [30,31]. From the polarization curves, the modified electrolyte/cathode interface with microstructures results in a reduction in losses and an increase in power density. The SOFC with 80 inkjet-printed layers at the interface had a maximum power density increase of 16 mW cm⁻², from 106 to 122 mW cm⁻². In comparison, the maximum power density for the SOFC with 160 printed layers increased 66 mW cm⁻², from 106 to 172 mW cm⁻². The power density is reported based on the same projected area as the SOFC with the planar electrolyte (i.e., no microstructures).

An increase in power density is expected as the effective surface areas increased with 80 and 160 inkjet-printed layers added to the interface. However, the effective surface area only increased 2.4 to 4.0% (Table 1) while the power density increased 15.1 to 62.3% (as shown in Table 2). This unexpectedly larger power density improvement is believed to be connected to the better electrochemical processes with the microstructures, which was further explored with EIS. Two samples of the SOFC with 160 inkjet-printed layers were tested and the total uncertainty was only ±6.0 mW cm⁻² at 0.55 V. This low uncertainty in comparison to the power density increase indicates that the results are repeatable and the performance increase is not due to precision error in the manufacturing. Similar results are shown in Table 2 for the SOFC with 80 inkjet-printed layers at the interface.

TABLE 2

| Number of layers | Number of samples | Power density | |
|---|---|---|---|
| printed | measured | (mW cm⁻²) | % Increase |
| Planar | 1 | 106 | NA |
| 80 | 2 | 122 ± 18 | 15.1 |
| 160 | 2 | 172 ± 6.0 | 62.3 |

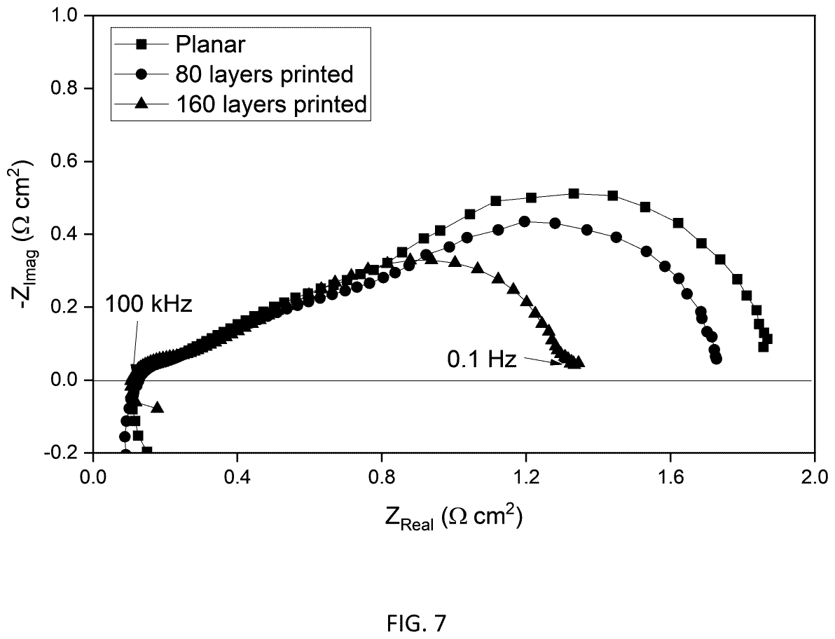

In addition to the polarization curves, the EIS measurements were also utilized for the SOFC performance evaluation. FIG. 7 shows EIS results of SOFCs with planar YSZ electrolyte, 40 layer, and 80 layer inkjet-printed microstructures, operating at 800° C.

As shown, an obvious impedance decrease can be noticed in both SOFCs with the 80 and 160 inkjet-printed layers. With a similar trend to the previous polarization curve results, the total impedance decrease for the SOFC with 160 inkjet-printed layers is larger than for the SOFC with the 80 inkjet-printed layers experiment compared to the planar electrolyte. The area specific resistance (ASR) for the planar electrolyte SOFC is about 1.7 mΩ cm². After adding the microstructures at the electrolyte/cathode interface, the ASR of the SOFC decreases to 1.6 mΩ cm² for 80 inkjet-printed layers and 1.4 mΩ cm² for 160 inkjet-printed layers. No major change in the ohmic resistance was noted in the EIS data, which is expected as the supporting anode layer and electrolyte layer are the main contributors to ohmic resistance and did not change for the SOFCs.

In the EIS results shown in FIG. 7, the SOFC had lower ASR with 80 and 160 inkjet-printed layers. However, the different electrochemical processes are overlapping in the EIS spectra and it is difficult to determine if the modification of electrolyte/cathode surface plays the most essential role in SOFCs performance improvement process. To separate the overlapping electrochemical processes in EIS results, distribution of relaxation times (DRT) analysis was conducted. A MATLAB GUI program (DRTtools) was used to analyze EIS data with the DRT method [32-34]. The regularization parameter of the DRT calculation is 10−3.

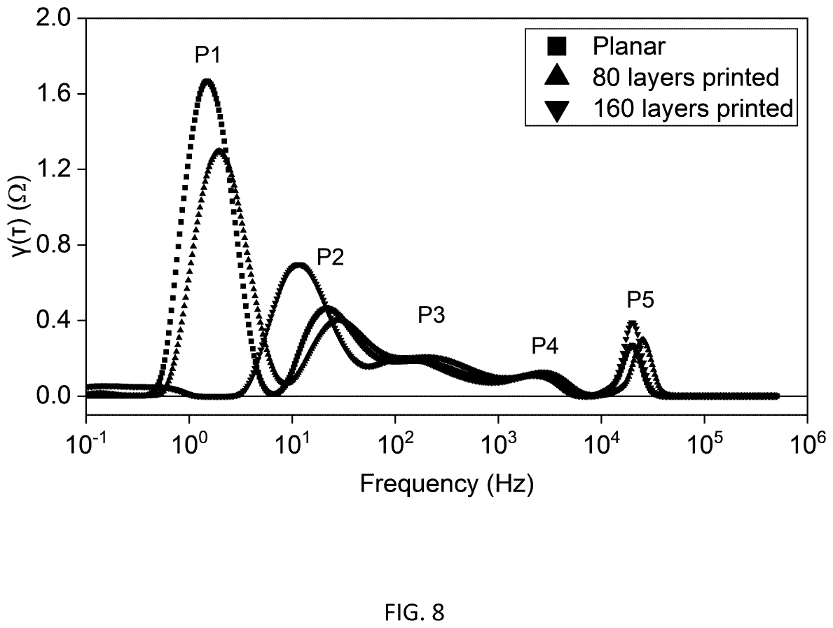

FIG. 8 shows a DRT plot from EIS results of SOFCs operating at 800° C. with planar YSZ electrolyte, 40 layer, and 80 layer inkjet-printed microstructures. From FIG. 8, five main separated peaks (P1˜P5) ranging from 10⁻¹ to 10⁵ Hz can be clearly distinguished when DRT analysis is conducted on the EIS data. According to previous references for SOFC DRT analysis with similar cells and operation conditions, the peaks relate to various types of polarization resistance [35-37]. For Ni-YSZ anode supported SOFCs, the P1 (˜1 Hz) has been attributed to the oxygen electrode surface kinetics [35-37]. The P2 appears around 10 to 100 Hz and is related to the fuel electrode gas diffusion and surface reactions [35-37]. P1 decreased and shifted to the right and appears to be combined with P2 for the 160-layer condition. Caliandro saw a similar effect of P1 decreasing and shifting towards peak 2 with increasing oxygen concentration using a standard SOFC setup [36]. This provides additional evidence that P1 is linked to the oxygen electrode reactions. In addition, a reduction in the oxygen mass transfer process in the cathode is expected as the microstructures penetrate the cathode, reducing the overall length of the path for oxygen diffusion. The P3 between 100 to 1 kHz is attributed to the gas diffusion in the anode supported layer [36,37]. The P4 (>1 kHz) and P5 (>10 kHz) are related to ionic transport in the anode and charge transfer processes, respectively.

From the DRT plot in FIG. 8, the main cause of the improved SOFC performance is the polarization resistance reduction in the cathode processes (P1). Generally, the P3, P4 and P5 remained unchanged. The addition of the microstructures at the electrolyte/cathode interface resulted in a reduction of the polarization resistance related to the oxygen mass transfer, the oxygen surface exchange kinetics and O2-diffusivity in the cathode. With a similar trend observed in polarization curves and EIS results, the SOFC with 160 inkjet-printed layers resulted in lower polarization resistance in the cathode related electrochemical processes than 80 layers. For the anode related electrochemical processes, no significant differences can be observed. DRT results can serve as evidence that the 3D inkjet-printed microstructures at the electrolyte/cathode interface in this study can improve the SOFCs performance by enhancing cathode related electrochemical processes.

Within this characterization of the particular embodiments of the contemplated SOFC, it can be confirmed that the modified electrolyte/cathode interface with microstructures can enhance the performance of SOFCs. Polarization curves and EIS results both demonstrate that the particular embodiment of the solid oxide fuel cell 100 with 160 3D inkjet-printed layers had better performance than the embodiment of solid oxide fuel cell 100 with only 80 layers or a flat interface. Generally, more layers of printing means a larger height and slightly larger diameter of the microstructures 102. With the same total number of microstructures 102, the SOFC with 160 printed layers has larger active area, which is considered as part of the reason for the SOFCs performance improvement.

From previous studies, optimization of the geometry of 3D structures has been proposed as the key for the cell performance enhancement. Jang et al. supposed that controlling the sharp microstructure edges is important in the 3D structure printing process [29]. From the theoretical calculations, Junya et al. found branches at the top side and complex wrinkle-like sub-structures at the bottom side can be an optimized geometry for the electrolyte/electrode interface. The height of the optimal structure can play a critical role for the length of the triple phase boundary (TPB) determination [38]. Shimura et al. also utilized numerical simulation methods to optimize the microstructure-based electrolyte structures and proposed that with sufficient percolation of each phase, increasing the width and height of microstructures 102 can both enhance the electrochemical performance. Increasing the numbers of the microstructures 102 can also reduce the ASR of the interface.

In this characterization of the particular embodiments previously discussed, instead of the perfect microstructure shapes examined in theoretical work, crater-shape microstructures were fabricated due to the coffee ring effect. It is possible that the sub-structures on the microstructures 102 may play a more important role than the size of microstructures 102. From the DRT analysis results, lower polarization resistance corresponding to the oxygen surface exchange kinetics for the SOFC with 160 layers printed may demonstrate the microstructures 102 have a better sub-microstructure. This can partly be attributed to the increase in active area caused by the taller microstructures 102 produced by the additional layers. A similar trend can be seen with the max power density observed, which increased with the increase in active area. However, the active areas only increased by approximately 4% with 160 inkjet-printed layers while the power density increased by ˜62% compared to a flat surface. This increase is not linearly related with the increase in active area, an unexpected result. This indicates that other factors, including the electrochemical processes, were influenced by the increased size of the microstructures 102 in unexpected ways.

The implications of the results should be considered when interpreting the significant increase in power density and decrease in polarization resistance. The cathode layer was relatively thin in these particular embodiments (˜17 μm) in comparison to other SOFCs with anode supported cells, which are ˜30 microns thick. Previous work has shown that a ˜30 microns thick cathode can lead to improved performance compared to a thin cathode [11]. However, having a thinner cathode with a reasonable power density (e.g., 172 mW cm⁻²) is an advantage as the cathode materials are generally the most expensive per unit mass when compared to the electrolyte and anode materials used in these particular embodiments.

Where the above examples, embodiments and implementations reference examples, it should be understood by those of ordinary skill in the art that other SOFCs and examples could be intermixed or substituted with those provided. In places where the description above refers to particular embodiments of SOFCs with 3D inkjet-printed microstructures and methods for fabricating the same, it should be readily apparent that a number of modifications may be made without departing from the spirit thereof and that these embodiments and implementations may be applied to other SOFC technologies as well. Accordingly, the disclosed subject matter is intended to embrace all such alterations, modifications and variations that fall within the spirit and scope of the disclosure and the knowledge of one of ordinary skill in the art.

### REFERENCES

1. E. Rillo et al., Energy, 126, 585-602 (2017).
2. A. Kromp, A. Leonide, A. Weber, and E. Ivers-Tiffée, J Electrochem Soc, 158, B980 (2011).
3. B. Shri Prakash, S. Senthil Kumar, and S. T. Aruna, Renewable and Sustainable Energy Reviews, 36, 149-179 (2014).
4. J. Van Herle, Y. Membrez, and O. Bucheli, J Power Sources, 127, 300-312 (2004).
5. R. J. Milcarek, J. Ahn, and J. Zhang, Sci Technol Built Environ, 23, 1224-1243 (2017).
6. J. A. Cebollero et al., J Eur Ceram Soc, 39, 3466-3474 (2019).
7. C. Sun, R. Hui, and J. Roller, Journal of Solid State Electrochemistry, 14, 1125-1144 (2010).
8. H. J. Ko, J. H. Myung, S. H. Hyun, and J. S. Chung, J Appl Electrochem, 42, 209-215 (2012).
9. K. Zhao, B. H. Kim, M. G. Norton, and S. Y. Ha, Front Energy Res, 6, 1-10 (2018).
10. A. Pesce et al., J Mater Chem A Mater, 8, 16926-16932 (2020).
11. A. Bertei, F. Tariq, V. Yufit, E. Ruiz-Trejo, and N. P. Brandon, J Electrochem Soc, 164, F89-F98 (2017).
12. H. Seo, M. Kishimoto, T. Nakagawa, H. Iwai, and H. Yoshida, J Power Sources, 506, 230107 (2021).
13. Y. Yao et al., IEEE Journal of Selected Topics in Quantum Electronics, 26, 1-6 (2020).
14. R. I. Woodward et al., Opt Express, 27, 15032 (2019).
15. D. Zhu, Z. Wang, and D. Zhu, J Electron Mater, 49, 1765-1776 (2020).
16. N. Karim, S. Afroj, S. Tan, K. S. Novoselov, and S. G. Yeates, Sci Rep, 9, 1-10 (2019).
17. T. Chen et al., Adv Funct Mater, 31, 1-11 (2021).
18. S. Lawes et al., Nano Energy, 36, 313-321 (2017).
19. A. Sajedi-Moghaddam, E. Rahmanian, and N. Naseri, ACS Appl Mater Interfaces, 12, 34487-34504 (2020).
20. P. Giannakou, M. O. Tas, B. Le Borgne, and M. Shkunov, ACS Appl Mater Interfaces, 12, 8456-8465 (2020).
21. M. R. Somalu, A. Muchtar, W. R. W. Daud, and N. P. Brandon, Renewable and Sustainable Energy Reviews, 75, 426-439 (2017).
22. N. A. Baharuddin et al., Int J Energy Res, 44, 8296-8313 (2020).
23. N. Shi et al., J Mater Chem A Mater, 5, 19664-19671 (2017).
24. S. Lee, K. Lee, Y. hoon Jang, and J. Bae, Int J Hydrogen Energy, 42, 1648-1660 (2017).
25. L. R. Pederson, P. Singh, and X. D. Zhou, Vacuum, 80, 1066-1083 (2006).
26. S. Kawale, I. Jang, N. Farandos, and G. H. Kelsall, React Chem Eng (2022).
27. N. M. Farandos, L. Kleiminger, T. Li, A. Hankin, and G. H. Kelsall, Electrochim Acta, 213, 324-331 (2016).
28. A. M. El-Toni, T. Yamaguchi, S. Shimizu, Y. Fujishiro, and M. Awano, Journal of the American Ceramic Society, 91, 346-349 (2008).
29. I. Jang and G. H. Kelsall, Electrochem commun, 137, 107260 (2022).
30. J. Tian and R. J. Milcarek, J Power Sources, 480, 229122 (2020).
31. J. Tian and R. J. Milcarek, Front Energy Res, 9, 1-13 (2021).
32. T. H. Wan, M. Saccoccio, C. Chen, and F. Ciucci, Electrochim Acta, 184, 483-499 (2015).
33. F. Ciucci and C. Chen, Electrochim Acta, 167, 439-454 (2015).
34. M. B. Effat and F. Ciucci, Electrochim Acta, 247, 1117-1129 (2017).
35. J. Hong, A. Bhardwaj, H. Bae, I. Kim, and S.-J. Song, J Electrochem Soc, 167, 114504 (2020).
36. P. Caliandro, A. Nakajo, S. Diethelm, and J. Van herle, J Power Sources, 436, 226838 (2019).
37. A. Leonide, Y. Apel, and E. Ivers-Tiffee, ECS Trans, 19, 81-109 (2019).
38. J. Onishi, Y. Kametani, Y. Hasegawa, and N. Shikazono, J Electrochem Soc, 166, F876-F888 (2019).
39. T. Shimura, K. Nagato, and N. Shikazono, Int J Hydrogen Energy, 44, 12043-12056 (2019).

What is claimed is:

1. A solid oxide fuel cell, comprising:
an anode layer comprising yttria-stabilized zirconia (YSZ) and NiO;
an electrolyte layer comprising YSZ deposited upon the anode layer;
a plurality of microstructures comprising a microstructure material and deposited upon the electrolyte layer, each microstructure composed of a plurality of layers of microstructure ink that have been applied by an inkjet printing system and sintered, the microstructure ink comprising YSZ; and
a cathode layer deposited upon the electrolyte layer and the plurality of microstructures, the cathode layer comprising lanthanum strontium manganite (LSM) and YSZ;
wherein each microstructure of the plurality of microstructures is shaped like a conical frustum having a first base and a second base, wherein the first base is substantially parallel to the second base, and wherein the microstructure is coupled to the electrolyte layer through the second base, and
wherein a ratio between an area of the first base and an area of the second base is less than 0.5.

2. The solid oxide fuel cell of claim 1, wherein each layer of the plurality of layers of microstructure ink is at most 0.3 μm thick.

3. A solid oxide fuel cell, comprising:
an anode layer;
an electrolyte layer deposited upon the anode layer;
a plurality of microstructures comprising a microstructure material and deposited upon the electrolyte layer, each microstructure composed of a plurality of layers of microstructure ink that have been applied by an inkjet printing system and sintered, the microstructure ink comprising the microstructure material; and
a cathode layer deposited upon the electrolyte layer and the plurality of microstructures.

4. The solid oxide fuel cell of claim 3, wherein each microstructure of the plurality of microstructures is shaped like a frustum having a first base and a second base, wherein the first base is substantially parallel to the second base, and wherein the microstructure is coupled to the electrolyte layer through the second base.

5. The solid oxide fuel cell of claim 4, wherein the frustum is a conical frustum.

6. The solid oxide fuel cell of claim 4, wherein the frustum is an elliptical frustum.

7. The solid oxide fuel cell of claim 4, wherein a ratio between an area of the first base and an area of the second base is less than 0.5.

8. The solid oxide fuel cell of claim 3, wherein each layer of the plurality of layers of microstructure ink is at most 0.3 μm thick.

9. The solid oxide fuel cell of claim 3, wherein each microstructure of the plurality of microstructures is composed of at least 160 layers of microstructure ink.

10. The solid oxide fuel cell of claim 3, wherein the anode layer comprises yttria-stabilized zirconia (YSZ) and NiO, the cathode layer comprises lanthanum strontium manganite (LSM) and YSZ, the electrolyte layer comprises YSZ, and the microstructure material is YSZ.

11. A method for fabricating a solid oxide fuel cell, comprising:
depositing an electrolyte layer upon an anode layer;
constructing a plurality of microstructures upon the electrolyte layer by printing a plurality of layers of microstructure ink directly on to the electrolyte layer using an inkjet printing system, the microstructure ink comprising a microstructure material; and
depositing a cathode layer upon the electrolyte layer and the plurality of microstructures.

12. The method of claim 11, further comprising creating the microstructure ink by ball milling the microstructure material and a solvent.

13. The method of claim 11, wherein each microstructure of the plurality of microstructures is shaped like a frustum having a first base and a second base, wherein the first base is substantially parallel to the second base, and wherein the microstructure is coupled to the electrolyte layer through the second base.

14. The method of claim 13, wherein the frustum is a conical frustum.

15. The method of claim 13, wherein the frustum is an elliptical frustum.

16. The method of claim 13, wherein a ratio between an area of the first base and an area of the second base is less than 0.5.

17. The method of claim 11, wherein each layer of the plurality of layers of microstructure ink is at most 0.3 μm thick.

18. The method of claim 11, wherein printing the plurality of layers of microstructure ink directly on to the electrolyte layer using the inkjet printing system comprises printing at least 160 layers of microstructure ink.

19. The method of claim 11, wherein the anode layer comprises yttria-stabilized zirconia (YSZ) and NiO, the cathode layer comprises lanthanum strontium manganite (LSM) and YSZ, the electrolyte layer comprises YSZ, and the microstructure material is YSZ.

20. The method of claim 11, wherein the electrolyte layer and the cathode layer are both deposited using a wet powder spray process.
